(19) United States
(12) Patent Application Publication
(10) Pub. No.: US 2005/0065819 A1
(43) Pub. Date: Mar. 24, 2005

(54) Electronic reimbursement process for provision of medical services

(76) Inventor: Pamela Lynn Schultz, Brookfield, WI (US)

Correspondence Address: QUARLES & BRADY LLP, 411 E. WISCONSIN AVENUE, SUITE 2040, MILWAUKEE, WI, 53202-4497, US

(21) Appl. No.: 10/944,109

(22) Filed: Sep. 17, 2004

Related U.S. Application Data
(60) Provisional application No. 60/504,364, filed on Sep. 19, 2003.

(51) Int. Cl. G06F 17/60

(52) U.S. Cl. 705/2

(57) ABSTRACT

A system for automatic tracking and payment for medical services is disclosed.

### CROSS-REFERENCE TO RELATED APPLICATION

The application claims the benefit of provisional application No. 60/504,364, filed Sep. 19, 2003, incorporated herein by reference.

### STATEMENT REGARDING FEDERALLY SPONSORED RESEARCH OR DEVELOPMENT

Not applicable.

### BACKGROUND OF THE INVENTION

Under the present health care system in the United States, medical service providers and facilities are typically reimbursed in two ways: through reimbursement from a payor and through payment from the recipient of the medical care in the form of co-pay's, deductibles or co-insurances. This model is found in industry both private and insurance realms and in government health services such as Medicaid and Medicare.

One problem with this reimbursement model is that, due to the significant amount of paperwork and the resultant delays involved in completing forms for reimbursement, submitting said claims to the payor and distributing reimbursement, it is unlikely providers of medical services receive reimbursement in a timely manner and it is difficult to track medical services provided to patients and success of protocols in delivering health care. For example, one major goal of Medicaid is to provide screening for children for various conditions so that health problems can be found and treated early to prevent serious complications. This type of screening, referred to as Early and Periodic Screening, Diagnostic and Treatment (EPSDT) requires states to provide adolescents under 21 yeas of age with access to comprehensive, periodic evaluations of health, developmental, and nutritional status, as well as vision, hearing, and dental services. States are required to report data related to these types of services to the Federal Government. Due to difficulties in obtaining and compiling data related to these types of services through provider and payor collaboration, a significant number of states are not in compliance with the reporting requirements. It is, therefore, very difficult to track the distribution of health care services and the effectiveness of the program and patient compliance/access in obtaining the services available to them.

Problems in administering and tracking Medicaid are shared with the managed care organization due to the high volume of data and data accuracy. Managed care organizations are typically paid by the state on a prepaid capitation basis, such as a per member per month fee, and provide access to a pre-selected group of providers. The combination of prepaid capitation payments and restricted choice can be argued to create incentive for providers to under treat in order to maximize profits. Furthermore, as multiple parties handle the claims, paperwork and associated payments, reporting is typically slow and unreliable.

Similarly, in private industry, managed care organizations are often used to provide health care services. In the insurance industry there is often a significant delay between the time when medical services are provided and the time when a medical service provider is reimbursed for the services. This also holds true in private industry when payors are required to reimburse medical providers and facilities for participation in research projects. The process of obtaining reimbursement is time consuming, paper-intensive, and labor-intensive, resulting in increased costs to the industry, consumers and providers.

It is therefore desirable to expedite payment to medical providers and facilities, track and identify patient access to available services and compliance to treatment protocols and reduce the amount of paperwork required for medical service providers to obtain reimbursement for medical services provided, both to minimize costs and to improve the ability to track the distribution of medical services and patient compliance to protocols. These goals are desirable both to improve government-sponsored health services, private health services, medical research and tracking of the distribution of health services.

### SUMMARY OF THE INVENTION

The present invention provides a method for tracking the provision of medical services to patients. The patients are provided with an identification card, including a unique patient identifier, preferably in a magnetic strip or other accessible digital data storage dynamic device. A medical service provider or facility retrieves the data from the card and transmits the data to a third party payor system (or third party central information clearing house) to determine if the patient is eligible for reimbursement from the third party payor. The third party payor system also includes a negotiated fee schedule for reimbursement of medical services. If the patient is eligible and medical services are performed, the third party payor automatically transfers funds to an account associated with the medical service provider. A report is generated for each of the patient, the medical service provider or facility, and the third party payor. Data about the medical services provided is also stored, either on the third party payor system, in the card, or both. The data can be retrieved to generate additional reports, track the use of services, and to track patient compliance.

The electronic reimbursement process for the provision of medical services provided in the present invention therefore allows payors, medical providers and facilities to track the data recovered during the process. This data can include, but is not limited to: conventional classification systems (for example; ICD-9-CM, ICD-10-CM, Sownmed), current procedural terminology (CPT), allowable amounts, billed amounts, co-payments, deductibles, co-insurances, provider identification numbers, personal health information about the cardholder, i.e., unique patient identification number, date of birth, allergies, advanced directive, etc. The electronic reimbursement process for provision of medical services can also capture serious adverse events; track compliance to program protocols and debit monies for services provided from the payor's account and immediately transfer the funds in real time to the provider's bank account.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF SEVERAL VIEWS OF THE DRAWINGS

FIG. 1 is a simplified block diagram of a medical reimbursement system.

FIG. 2 is a flow chart illustrating a medical reimbursement method.

### DETAILED DESCRIPTION OF THE PREFERRED EMBODIMENT

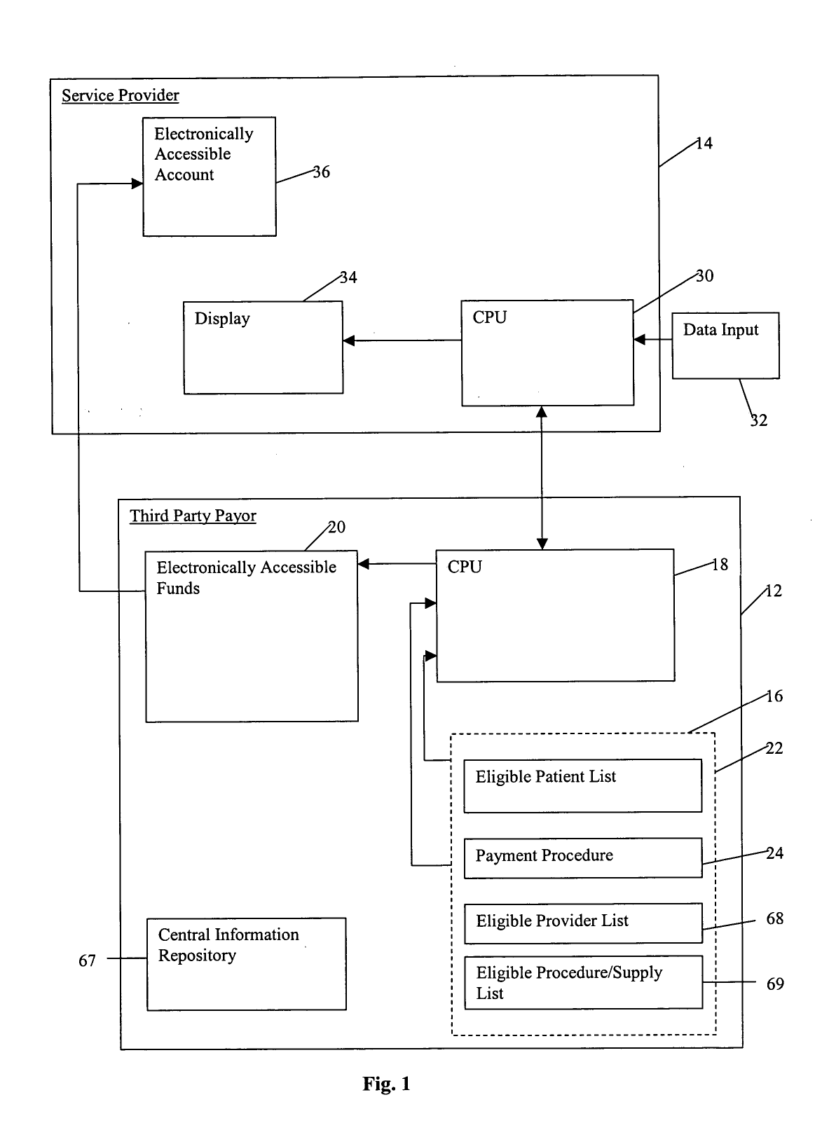

Referring now to the Figures and more particularly to FIG. 1, a block diagram of a medical reimbursement system constructed in accordance with the present invention is shown. The medical reimbursement system comprises a third party payor system 12 which can be directly linked to one or more medical services provider(s) and or facilities system 14 to effect automatic tracking of medical services and reimbursement of funds, as described below and a central information repository 67 for storage of all data/transactions. The third party payor system 12 receives patient data from the medical services provider system 14, verifies that the patient requesting service is eligible, tracks medical procedures, and distributes funding based on a predetermined pay schedule, as described more fully below.

Referring still to FIG. 1, the third party payor system 12 includes a memory component 16, a processing unit 18, and an electronically accessible source of funds 20. The processing unit 18 is configured to transmit and receive data from the medical service provider system 14, and is further connected to the memory component 16 to receive and store information, and to electronically transfer accessible sources of funds 20 as required, as described below.

The memory component 16 stores a patient eligibility list 22, payment or a fee/procedure list 24, an eligible provider list 68, an eligible procedure supply list 69, and a central information repository 67. The patient eligibility list 22 includes at least one unique patient identifier for identifying a patient eligible to receive reimbursement, and can also include various other data required by both the third party payor and the medical services provider which can be, for example, a patient name and unique patient identification number, coverage information including applicable co-pays, deductible or coinsurance, address, allergies and other similar information. The eligible provider list similarly includes a list of providers who have been certified to provide medical serivdes, such as, for example, by Medicare, Medicaid, or another third party payor, typically with an associated number assigned by the payor or other identifier. The eligible procedure/supply list 69 includes data related to which procedures and supplies are covered by the specific payor.

The fee/procedure list 24 includes a schedule of current procedural terminology (CPT), a conventional classification system (for example; ICD-9-CM, ICD-10-CM, Snowmed) schedule and a fee payment schedule for one or more medical procedure(s) to be performed by the medical services provider/facility, and can also corresponding insurance benefit information such as applicable co-pays, deductible or coinsurance, as well as other information related to other sources of funding. The fees for medical procedure are pre-negotiated established fees. As payments are made directly upon disbursement of medical services, these negotiated fees can be lower than the fees normally paid to the provider, as the reduction in paperwork and collection services reduces costs to the provider, and a financial advantage is gained by receiving the fees immediately.

Data related to each transaction, including, for example, patient identification, provider information, procedure or supply, and funds transferred is stored in the central information repository 67. This information, as described below, can be used to generate reports.

The medical services provider system 14 includes a processing unit 30, a data input or entry device 32, a display 34, and an electronically accessible account 36 for storing transferred funds. The processing unit 30 is configured to receive data from and transmit data to the processing unit 18 of the third party payor system 12, to the data input device 32 to receive patient and procedure data, and to the display 34 to provide information regarding eligibility and the fees associated with a particular procedure to the medical services provider. The electronically accessible account 36 is connected to the electronically accessible source of funds 24 in the third party payor system 12, wherein reimbursement for the procedure can be made by the payor to the provider of medical services upon swiping the patient identification card and the funds are immediately and directly transferred upon completion of the procedure.

The data entry device 32 can be any of a number of known devices including a keyboard, scanner, bar code reader, other devices, or a combination of such devices. Preferably, the data entry device 32 includes a magnetic strip reader in which a patient identification card can be quickly and easily “swiped”, as described below. One such device, is the Tranz 460 Integrated Processing System, which combines a card reader and keyboard for data entry, and can communicate directly with the payor system 12.

The patient is provided with a patient identification card that, as described above, can include a magnetic strip or other data storage capabilities for storing patient identification and other data. The patient card may also be associated with a pre-determined amount of funds to be dispensed, as well as out of pocket liability for the patient including information co-pays, deductibles and coinsurance. The patient identification card may also include a patient identification number which can be keyed into the data entry device 32, or include various other data storage devices and identifiers. The patient identification card will also provide tracking ability for the medical provider/facility to monitor patient compliance to treatment protocol and possibly severe adverse events when used in conjunction with research projects. The tracking mechanism associated with the card can be utilized by the payors to insure specific benefit designs are adhered to such as certain limitations placed on services or visits and it can also be utilized to assure access to preventative services are being sought such as: early and periodic screening, diagnostic and treatment, diabetic testing, mammography and blood pressure screenings, required vaccinations, etc.

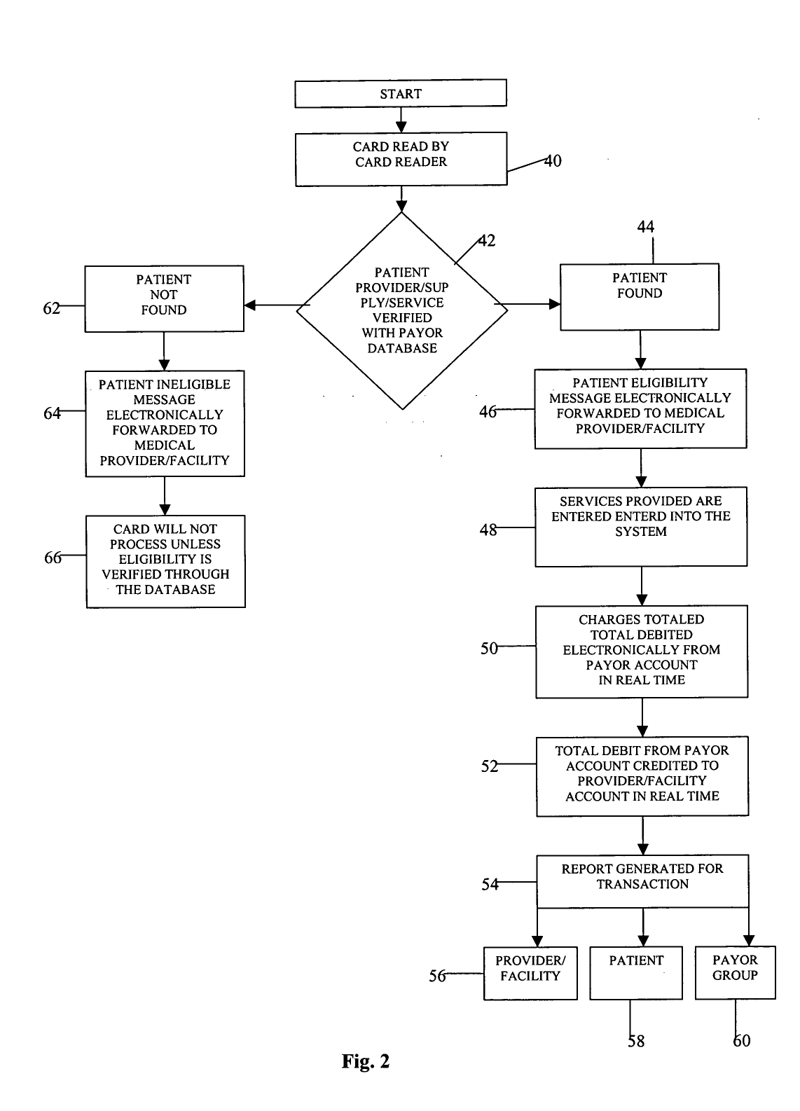

Referring now to FIG. 2, a flow chart of the payment reimbursement process of the present invention is shown. Initially, when a patient enters the office of a medical service provider, he or she presents an identification card including a magnetic data strip readable by a magnetic card reader, or other digital data storage medium. After the card is presented to the staff at the medical service provider, it is swiped through a card reader or other reading device provided at least as part of the data entry device 32 (step 40), and the processing unit 30 compares the data on the card against data retrieved from the patient eligibility list 22 described above (step 42). If the patient identification data is verified (step 44), a message is provided on the display 34 (step 46) to the medical service provider system 34, verifying that the patient is eligible for reimbursement. The medical services to be provided to the patient can be entered into the service providor system 14, and provider eligibility for the requested services can also be verified against the eligible provider list 68 in the memory component 16 of the third party payor system 12 to verify eligibility of the provider for reimbursement.

Upon completion of the patient visit, medical services provided to the patient are then entered into the medical service provider system 14 through the data entry device 32 (step 48). Upon completion of the services, the fees payable for all of the medical services are totaled (step 50), and the funds are electronically transferred from the electronically accessible source of funds 70 controlled by the payor system 12 to the electronically accessible account 36 held by the medical services provider system 14 (step 52). These funds can be only those funds owed by the third party payor, or in the alternative, can include patient liability such as co-pays or other fees. After the funds are transferred, a report is generated (step 54), a report is provided for the medical services provider (step 56), for the patient (step 58), and for the third party payor (step 60), and further, is stored in the central information repository 67 in the third party payor system 12. The report can be printed or stored in memory. This data is then used to track various elements required by the provider of medical services such as compliance and by industry such as tracking of adherence to benefit design such as visit limitations or seeking of preventative services. Furthermore, the data acquired can be compiled and stored for generation of additional reports as, for example, reports required to be generated for Medicaid. For example, therefore data for a selected population can be categorized and retained in memory 16 by the third party payor and transmitted printed, or reconfigured into other reports with assurance that the data provided is accurate and current because it is obtained at the point of service provision by the service provider and not routed through other paper channels or personnel where data entry errors are more likely to occur as the handling and recording of the information increases. Furthermore, the present system can be used to track and report services that were requested and denied, either due to ineligibility of the patient or the service provider. This data can be used, for example, to re-evaluate types of services required and locations for providing these services.

The reimbursement model provided in the present invention provides significant advantages over prior art payment models in a number of ways. First, it decreases the amount of time, labor, and other resources engaged in the collection of payment for medical services. Secondly, it improves the ability of service providers to report, and therefore for agencies and other interested parties to track medical services by providing direct reporting of the services provided. Thirdly, it offers industry the ability to monitor patient compliance to benefit design and for providers of medical services to monitor patient compliance to treatment protocol. Finally, due to the reduced overhead and immediacy of payment, it is feasible to expect the providers of medical services to accept reduced pre-negotiated fees for services rendered and, further, to encourage medical service providers to participate in programs such as Medicaid and Medicare, research initiatives and managed care plans with the expectations they will receive payment for services rendered the same day services are provided.

Although a specific embodiment has been described above, it will be apparent to one of ordinary skill in the art that there are many hardware and software configurations which could be used in the present invention. The third party payor system 12, for example, can be linked to the medical services provider system 14 through LAN, WAN, internet, satellite, telephone lines, or various other communication links. The hardware provided in the third party payor system 12 and medical services provider system 14 could be various types of computer systems, servers, point of sale, and communication terminals, or other devices. Additionally, although described specifically with reference to a computerized system, various aspects of the invention could also be performed via telephone or in other less automated ways.

While there has been shown and described what are at present considered the preferred embodiments of the invention, it will be obvious to those skilled in the art that various changes and modifications can be made therein without departing from the scope of the invention defined by the appended claims.

1. A method for reimbursing medical providers with funds from a payor, the method comprising the following steps:
establishing an electronically accessible payor account storing funds for payment of medical services;
establishing a payee account for receiving funds for payment of medical services;
providing a patient database including patient identifiers for patients who are eligible to receive payment for medical services from the payor;
storing a procedure price database correlating at least one medical procedure with at least one medical procedure payment price;
comparing a patient identification presented by the patient to the patient eligibility data in the patient database to determine if the patient is eligible for reimbursement;
providing the medical procedure if the patient is eligible; and
electronically transferring a sum equivalent to procedure price from the payor account to the payee account when the procedure is complete.

2. The method as defined in claim 1, further comprising the step of storing the patient identification information on a card.

3. The method as defined in claim 2, further comprising the step of storing the patient identification information in a magnetic strip on the card or other digital storage format.

4. The method as defined in claim 3, wherein the step of comparing the patient identification to the patient eligibility data comprises retrieving the patient identification data from the magnetic strip or other digital storage media, comparing the patient identification data to the patient eligibility data, and providing a message to the medical provider that the patient identification data matches.

5. The method as defined in claim 1, further comprising the step of generating a report.

6. The method as defined in claim 1, further comprising the step of assuring that the medical provider is eligible for reimbursement to provide the services.

7. A system for electronic payment of medical bills by a third party payor, the system comprising the following:
a patient eligibility database storing patient identification data;
a medical procedure database storing a procedure price to be paid by the third party payor for at least one medical procedure;
a third party payor funds account linked to the medical procedure database;
a communications link for selectively linking the non-covered services to service providers supplied or attempted to supply including but not limited to prescriptions, durable medical goods, etc.
a data entry device for entering patient data at the medical service provider;
a processor connected to the data entry device to receive patient data from the data entry device and to the communications link to access the patient eligibility database and the medical procedure database; and
a medical service provider account connected to receive funds from the third party payor account when a medical procedure is complete.

8. The system as recited in claim 7, further comprising a provider eligibility database for verifying the eligibility of the service provider for repayment.

9. A system for electronic reimbursement to service providers by third party payors of medical services, the system comprising:
a third party payor system including:
a memory component storing data related to patient eligibility and data related to payment prices for medical procedures;
a processing unit for retrieving data from the memory and transmitting data to service providers; and
an electronically accessible source of funds for transmitting a payment for the services to a medical service provider;
a medical service provider system comprising:
a data input device for entering patient identification data and procedure data;
a processing unit for receiving the patient and procedure data from the data input device, and for communicating data with the third party payor system;
a display for providing data to the medical service provider; and
an electronically accessible account for receiving transferred funds,
wherein when a patient enters a medical facility, patient identification data is entered into the data input device and compared to patient eligibility data to determine if the patient is eligible for reimbursement by the third party payor system and, if the patient is eligible, from the same electronically accessible account as payment for the medical services) from the electronically accessible source of funds to the electronically accessible account, and patient and procedure data is stored in a database.

10. The system as recited in claim 9, wherein the payment for services is transmitted from the third party payor system to the medical service system electronically.

11. The system as recited in claim 9, wherein the third party payor system further comprises a database of patient fees.

12. The system as recited in claim 9, wherein the patient fees include co-payment fees.

13. A method for tracking medical services provided to a patient or a class of patients, the method comprising the following steps:
issuing a card including a data storage medium storing a unique patient identifier to at least one patient;
retrieving the unique patient identifier at a medical service provider or facility, and comparing it to a stored list of eligible patients for receipt of reimbursement from a third party payor;
providing medical services when the patient is eligible;
automatically transferring a predetermined fee from a third party payor account to a medical service provider account for the medical services; and
storing data related to the medical services;

14. The method as defined in claim 8, further comprising the step of evaluating the data related to the medical services for patient compliance.
